(19) United States
(12) Patent Application Publication
(10) Pub. No.: US 2005/0183751 A1
(43) Pub. Date: Aug. 25, 2005

(54) Method and apparatus to enhance decontamination of very-fine-grained soil particles

(76) Inventor: Kenneth Gaylord Parrent, Fairfield, MT (US)

Correspondence Address: Kenneth G. Parrent, 148 E DIVISION, FAIRFIELD, MT, 59436, US

(21) Appl. No.: 10/783,009

(22) Filed: Feb. 23, 2004

(51) Int. Cl. B08B 9/20

(52) U.S. Cl. 134/34; 134/109

(57) ABSTRACT

An apparatus and method are described for improved efficiency in washing resistant contaminating chemicals, metals, hydrocarbons, and radioactive substances from very-fine-grained soil particles. Decontamination is accomplished by two opposing streams of high-velocity wash fluid each depressed at 10° being introduced into a faceted wash chamber at a relative velocity of 500 to 1500 feet per second. Two streams of contaminated slurry are introduced into each high-velocity, high-kinetic-energy wash-fluid stream forming an admixture which is accelerated onward into a multifaceted wash chamber. The process constitutes five washing stages within a metal enclosure designed to efficiently utilize the significant quantity of kinetic energy available in incoming, high-velocity wash fluid by maintaining a high level of turbulence and shear among the particles of the admixture. The design of the apparatus provides 400% of the kinetic energy of a single stream of wash fluid. It is the express purpose of this invention to provide means to effectively utilize the significant quantity of kinetic energy to dislodge contaminants from fine-grained soil particles. The apparatus and process herein disclosed substantially reduce the costs and problems experienced by traditional methods employed in washing very fine-grained soil particles.

### BACKGROUND OF THE INVENTION

1. Field of the Invention

This invention relates to decontamination of fine-grained soil particles and is more particularly concerned with an improved apparatus for subjecting very fine-grained soil particles to a very high level of kinetic energy in a continuous multi-stage washing process within a multi-faceted enclosure designed to control the expansion of turbulence and maintain the velocities of the particles in the admixture to maximize inter-particle shear and washing.

2. Description of the Prior Art

Environmental concerns of our society have caused the development of various methods for the purpose of washing contaminants from soil particles. Some of said methods utilize spray-washing of soil particles on moving or rotating screens; turbulence-producing propellers or paddle systems in slurries of soil particles; jets at the surface of slurries in tanks or jets submerged in slurries of soil particles and the like. All of the foregoing methods and others are work-and-time-intensive as the concentration of contaminants is sought to be reduced to environmentally acceptable standards. The practice of spray-washing soils on screens encounters problems such as washing fluids by-passing soil particles, upper layers of soil particles shielding lower layers, high fluid volume requirements with attendant dirty-fluid disposal problems, extensive equipment costs, fluid-recycling requirements to reduce contaminants concentration and the like. The many uses of turbulence-producing devices such as rotating paddles or propellers in baffled tanks are limited in their abilities to generate high-velocity turbulence to accelerate the admixture and develop shear rates necessary to displace resistant compounds of chemicals, metals, hydrocarbons, radioactive substances, and the like from fine-grained soil particles. One of the limiting factors in the use of rotary washing devices, i.e. propellers, is the cavitation attending high-speed rotation. Cavitation results in wasted energy, excessive equipment maintenance, noise, vibration, and the like, and it still falls short of efficiency. Other methods have been employed such as jetting into open-top tanks and also the use of submerged jets. In either case, the turbulent plume of admixture discharged from said jet dissipates very quickly in the fluid media being treated due to the expansion of the incoming stream and the resistance of the fluid the jet stream is entering. The attendant dissipation of the incoming jet-stream velocity deprives said stream of the kinetic energy therein and thus the capability of the washing-fluid stream to create the shear required to remove tenacious contaminants from fine-grained soil particles. A great deal of research has been conducted to gain understanding of fluid jets entering fluids. One of the problems accompanying the use of jets in fluid media is the creation of streamlines paralleling the path of the jet stream. Said streamlines characteristically create conditions of minimal shear due to low-particle-relative-velocity, fluid cushioning and adhesive drag between constituents. Further, energy dissipation in the incoming jet stream is due to the turbulent “cloud” it creates while expanding and simultaneously rapidly loosing its velocity and, therefore, its kinetic energy and shearing ability to remove contaminants from fine-grained soil particles.

Fine-grained soil particles are very resistant to washing by any of the foregoing methods. All of the problems described above are compounded as grain size diminishes. Larger particles in fluid media have adequate mass and, therefore, adequate inertia to resist to some degree the drag forces in a moving stream of washing fluid. As a result the surfaces of particles greater than 2,000 microns in diameter, for example; experience shear forces from moving wash water that can remove minute quantities of contaminant from the particles surfaces because the larger particles have some inertial resistance to movement by turbulent wash water. In contrast to the response of larger particles, i.e. particles having diameters greater than 2,000 microns, particles of less than 2,000 microns can be displaced more readily by particles of wash water and thus the shearing effect on the smaller particle's contaminants is reduced. As the soil particle diameter decreases its mass will also generally decrease and, therefore, its inertia decreases and it becomes more easily moved by a particle of wash fluid. Thus the shearing effect of a moving particle of wash water is diminished. The removal of contaminants from soil particles ranging between 20 and 500 microns in diameter becomes exceedingly difficult due to their small mass and low inertia and their susceptibility to being moved by the wash fluid. Also many of the problems encountered by conventional soil washing methods result from the adhesive forces between the soil particles and the contaminants thereby making their removal from the soil particle a difficult task. Cohesive forces between particles of contaminant also contribute further to the difficulties encountered by conventional soils washing methods. Of no small concern in conventional soil washing activities is the generation of voluminous quantities of dirty water containing minute quantities of removed contaminants. Said dirty water cannot be reused until it has been filtered and itself decontaminated. The physical plant in many cases is quite large, cost intensive, and expensive to operate. A major advantage of this invention is the efficient use of high levels of kinetic energy in smaller volumes of high-velocity wash fluid instead of the conventional use of low kinetic energy, low velocity, and high volumes of wash fluid because treating and cleaning large volumes of wash fluid is a major operating expense. It has been found that many of the problems hither to encountered in the art of soil washing can be reduced or eliminated using the apparatus and process described hereinafter.

### SUMMARY OF THE INVENTION

This invention comprises an apparatus and a method for improving decontamination of very-fine-grained soil particles by overcoming several of the above-mentioned problems now complicating conventional methods of washing resistant chemical, metallic, hydrocarbon, and radioactive contaminants from very fine-grained soil particles.

Said invention provides means for improved efficient use of kinetic energy in a washing fluid by restricting movement of slurried, contaminated admixture within a multi-faceted washing chamber while repetitiously subjecting said particles of said slurry to extreme shear with very-high-velocity wash fluid wherein expansion of turbulence is strictly limited to achieve an efficient high-kinetic energy, continuous washing process which includes no moving parts and uses only the flow of the admixture through said apparatus to accomplish said desired decontamination of fine-grained soil particles.

### BRIEF DESCRIPTION OF THE DRAWINGS

One embodiment of the invention has been chosen for purposes of illustration and description and is shown in the accompanying drawings forming a part of the specification wherein:

FIG. 1: Is a perspective representation in cross section of a side elevation of one half of one embodiment of an apparatus for washing tenacious contaminants from fine-grained-soil particles in accordance with the invention. The other half is a mirror image of FIG. 1.

FIG. 2: Is a schematic diagram showing a soil-washing system depicting the high-shear washing device employing the present invention 11, slurry tank 23, washing-fluid tank 3, slurry transfer conduits 4, washing-fluid transfer conduits 10, high-pressure washing-fluid pump 25, dirty water and cleaned soils discharge conduit 12, dirty-water and soil-separation 10, cleaned soils to land fill 19, cleaned wash water to be recycled 20, wash water return conduit 22 to supply tank 3.

### DESCRIPTION OF THE PREFERRED EMBODIMENT

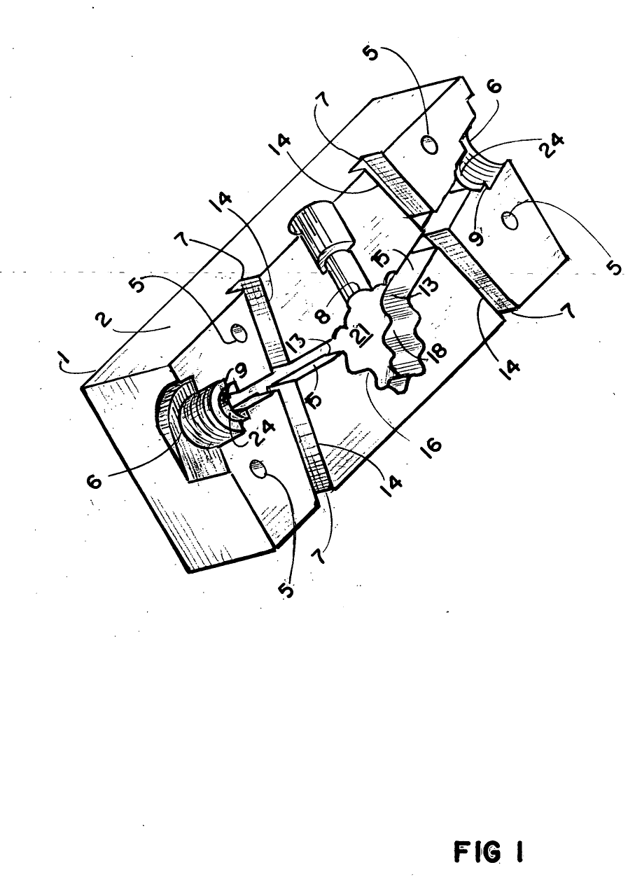

Referring to FIG. 1 of the drawings, there is shown one half of an apparatus in accordance to be used for washing contaminants from fine-grained-soil particles. FIG. 1 is the invention mirror image of the other half of the apparatus.

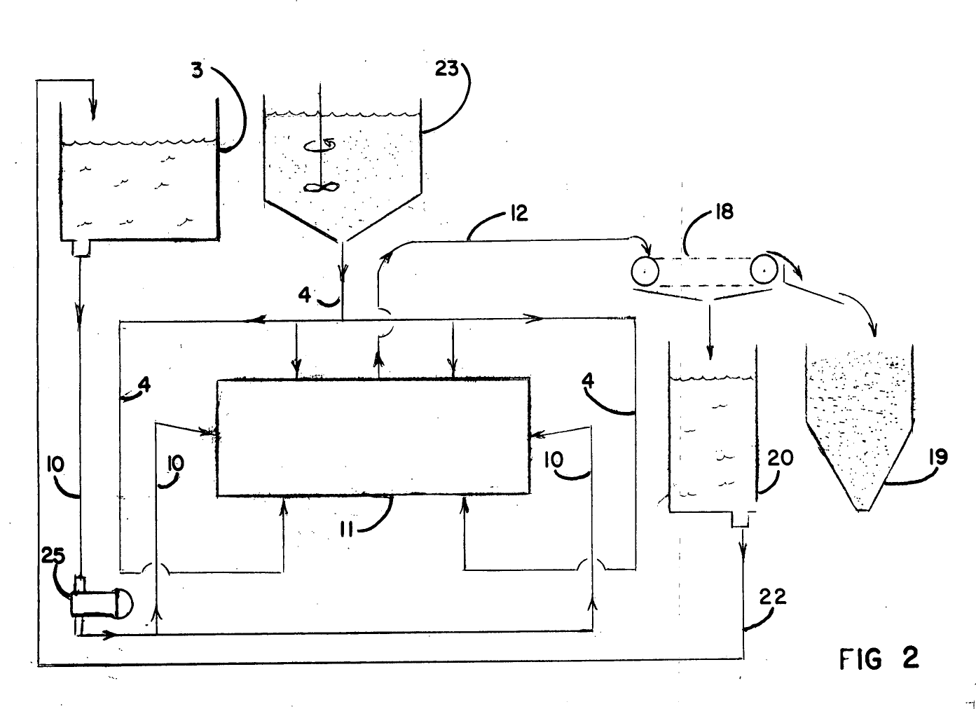

The apparatus includes an enclosure having a rectangular body portion 1 defined by external wall surface 2 and internal passages 14 and 15 machined into said metal body which is constructed in two matching halves only one of which is shown. The two halves are assembled for operation by bolting them together in alignment using commercially available bolts, not shown, through holes 5 prepared for same. The metal body 1 is constructed with means to receive commercially available high-pressure fluid conduits 10, FIG. 2 assembled into said metal body at threaded inlet openings-6. Said high-pressure fluid (2,000 psi) conduits are supplied with high-pressure wash fluid by a commercially available pump 25, FIG. 2 rated to deliver the fluid volume and pressure required for the specified process.

Four slots 7 provide means for feeding low-pressure contaminated slurry into said internal passages 15 at an angle of 90°. Said low-pressure contaminated slurry combines with and is washed by high-velocity wash fluid supplied through inlets 6 and nozzles (commercially available, not shown) at position 24. Said low-pressure slurry entering passages 14 through slots 7 will hereinafter be referred to as the “secondary streams” and said high-pressure, high-velocity fluid entering passage 15 through said nozzles at position 24 will be referred to as “primary streams”. Said secondary streams enter said primary streams with minimum consumption of the kinetic energy in said primary streams as said primary streams contact and accelerate said secondary streams down passages 15 toward a faceted washing chamber 16. The contact between the said primary and said secondary streams at the internal opening of passages 14 is the first of five stages of high-velocity, high-shear washing to take place within the device.

Said secondary streams of slurry entering passages 14 through slots 7 are provided from a slurry tank 23, FIG. 2 at low-pressure via commercially available piping means 4, FIG. 2 attached to said steel washer body by welding. Said high-pressure fluid conduits (commercially available) attached to said steel body 1 at openings 6 are fitted with commercially available piping and sealing devices such as “o” rings (not shown) which seal against commercially available nozzles (not shown) seating against retaining flanges 9 machined into said steel body 1. Said nozzles discharge primary streams of high-velocity wash fluid into said primary passages 15. Said primary streams contact at 90° angles said secondary streams entering said pry passages 15 through secondary passages 14. Said contact of said primary streams with said secondary streams is the first of five washing stages designed into the device as will be explained later.

Said primary streams accelerate said secondary streams to a velocity of approximately 500 to 600 feet per second into entrance 13 of the faceted washing chamber 16 from each end of primary passage 15. The relative velocity of the two primary streams with respect to each other approximates 1200 feet per second as they enter said faceted washing chamber 16 at position 13. At position 13, the entrance to said faceted washing chamber 16 said incoming streams of high-velocity admixture of said wash fluid and said slurry particles commingles with turbulent admixture that has previously entered said faceted washing chamber 16 in high-shear washing-stage number two of the process. As said incoming admixture of said primary and said secondary streams continues from entrance 13 of said faceted washing chamber 16 on into said chamber 16, washing stage number three takes place as said two incoming streams of admixture meet in said faceted washing chamber under high shear conditions at a combined velocity approaching 1200 feet per second. At this point in the process said incoming admixture still retains much of said kinetic energy it contained upon entering said faceted washing chamber at a downward angle of approximately 10°. Said downward orientation of passages 15 has the dual purpose of causing said incoming, high-velocity streams to deflect each other away from exit 8 to prevent premature escape of said admixture through said exit 8 and also to cause said incoming streams of admixture to be deflected to and impinge on the multi-faceted bottom surfaces 18 of said washing chamber. Said admixture then ricochets upward through violent turbulence and shear at various angles into and through the paths of said admixture entering said washing chamber 16 from passages 15 in area 21 in what is designated as washing stage five. Said decontaminated admixture now exits said washing chamber 16 through exit opening 8 where it is conducted by suitable commercially available conduit to final filtration, rinsing and removal of the fine-grained solids (now decontaminated) and treatment of said wash fluid for recycling.

The result of the efficient usage of the kinetic energy in high-velocity washing within this energy-conserving device results in removal of said resistant contaminants from said fine-grained soil particles with the generation of much less dirty water to filter and neutralize. Other major benefits from using said subject invention are lesser capital investment, less operating personnel, fewer problems in disposal of washed solids, portability and versatility.

Although said invention has been described in conjunction with said foregoing specific embodiment, many alternatives, variations and modifications will be apparent to those of ordinary skill in the art. These alternatives variations and modifications are intended to fall within the spirit and scope of the appended claims.

1. A method and apparatus for washing contaminants from very-fine-grained soil particles comprising the steps of:
Pumping a first high-velocity, high-kinetic-energy stream of wash fluid through a first nozzle at a velocity greater than 500 feet per second at a downward angle of approximately ten degrees from one end of said washing apparatus;
simultaneously pumping a second high-velocity, high-kinetic-energy stream of wash fluid through a second nozzle at a velocity greater than 500 feet per second at a downward angle of approximately ten degrees from the opposite end of said washing apparatus;
flowing two streams of low-velocity, low-kinetic-energy contaminated slurry into the path of each of said first and said second streams of high-velocity, high-kinetic-energy wash fluid thereby causing washing step number one;
said first and second streams of combined high-velocity, high-kinetic-energy wash fluid and low-velocity, low-kinetic-energy contaminated slurry constitute two streams of admixture continuing down separate opposing passages sloping at approximately ten degrees from each end of said apparatus;
said streams of admixture are each moving at a velocity of approximately 600 feet per second;
said high-velocity, high-kinetic-energy streams of admixture enter a faceted wash chamber midway within said soil-washing apparatus;
upon said streams of admixture entering said faceted wash chamber said streams merge in high-velocity, high-kinetic-energy contact with admire previously injected into said washing chamber within a confined, turbulent environment thereby causing washing stage number two;
said two streams of admixture continue on into said faceted washing chamber from opposite ends of said washing apparatus at a velocity relative to each other of approximately 1200 feet per second to intersect in high-shear, high-kinetic-energy washing-phase number three;
upon intersecting each other said high-velocity, high-kinetic-energy streams of admixture deflect each other in a generally downward direction at high-velocities to contact said faceted inner surfaces of said washing chamber;
whereupon said admixture undergoes turbulent, high-shear, high-velocity washing stage number 4;
said admixture is then deflected from said washing-chamber faceted surfaces in generally upward directions to;
intersect said high-velocity admixture entering said washing chamber from said primary passages thereby completing the fifth of a total of five washing stages in a high-shear environment of confined turbulence;
said admixture, now virtually devoid of kinetic energy, exits said washing chamber at a relatively low-velocity and a low-level of kinetic energy;
all interactions between said high-velocity fluid streams, slurry streams, admixture streams, and faceted wash-chamber surfaces are intended, by design, to remove resistant contaminants from fine-grained soil particles.

2. An apparatus for cleaning resistant chemical, metallic, hydrocarbon, and radioactive contaminants from very-fine-grained soil particles, said apparatus comprising:
a means for pumping very-high-velocity, high-kinetic-energy wash fluid from a storage tank through a first nozzle into a first primary passage within one end of a metallic rectangular, soil-washing apparatus consisting of two mirror-image matching halves joined securely together;
by pumping said wash fluid through a second of said nozzles into a second primary passage opposite said first primary passage within said washing apparatus;
said primary passages each having two secondary passages intersecting each of said primary passages;
said secondary passages positioned with one each of said secondary passages intersecting each of said primary passages at an angle of 90 degrees from the top of said primary passage;
and with one each of said secondary passages intersecting each of said primary passages at an angle of 90 degrees from the bottom of said primary passage;
each of said primary passages sloping downward at an angle of approximately ten degrees into a multifaceted washing chamber centralized within said washing apparatus;
said primary streams of said high-velocity, high-kinetic-energy wash fluid intersecting said streams of contaminated slurry flowing from a slurry tank through said secondary passages into the paths of said high-velocity streams of primary wash fluid;
thereby forming two streams of admixture which said high-velocity primary streams of wash fluid accelerate and carry along said primary passages into said multifaceted wash chamber;
said high-velocity streams of said admixture entering said multifaceted wash chamber from opposite ends of said apparatus meet in high-shear interaction at the center of said multifaceted wash chamber;
as a result of said downward slope of each of said stream of admixture said streams of admixture deflect each other in a generally downward direction to impact, at high-velocity, upon said multifaceted sure of the bottom of said multifaceted wash chamber,
said multifaceted surfaces of said wash chamber cause high-velocity, high-shear deflection of said admire in a generally upward direction;
said deflection carries said high-velocity admixture into the paths of said streams of admixture entering said wash chamber from said opposing primary passages;
said admixture now continues into and out through a single exit opening in the top of said multifaceted wash chamber;
said admixture has now depleted virtually all of its kinetic energy in said series of five defined soil-washing interactions;
said admixture now continues via commercial conduit into a system of commercially available equipment to separate said liquids from said solids;
to rinse said solids;
to neutralized said wash fluid;
to dispose of said decontaminated soils;
and to recycle said wash fluid for reuse.
